(19) United States
(12) Patent Application Publication
(10) Pub. No.: US 2004/0163754 A1
(43) Pub. Date: Aug. 26, 2004

(54) Reactivation of pre-applied adhesives by ultrasonic waves

(76) Inventors: James W. Nowicki, Hopewell, NJ (US); Yimin Zhang, Somerset, NJ (US); Demetrius T. McCormick, Belle Mead, NJ (US); Zhixin Li, Bridgewater, NJ (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 10/371,671

(22) Filed: Feb. 22, 2003

(51) Int. Cl. B32B 13/00

(52) U.S. Cl. 156/73.1; 428/343; 156/347

(57) ABSTRACT

A reactivatable adhesive that may be used on high speed case and carton sealing lines contains an energy absorbing ingredient that is capable of reactivating upon exposure to ultrasonic energy.

### FIELD OF THE INVENTION

The invention relates to adhesives. More specifically, the invention is directed to reactivatable adhesives and uses thereof, in particular adhesives reactivated by the application of ultrasonic waves.

### BACKGROUND OF THE INVENTION

In conventional case and carton packaging process for food and consumer goods, boxes are typically filled with food or consumer goods, then a hot melt adhesive is applied to the flap of boxes on the packaging line and compression is exerted to seal the boxes. While this process works reasonably well, it requires the packaging company to devote a tremendous amount of time and attention to adhesive-related issues, including adhesive selection, processing, trouble-shooting, inventory, and maintenance of adhesive application equipment. First, selection of an adhesive having the required adhesion, setting speed, and open time is a lengthy process. Then the adhesive needs to be processed in an appropriate way such as melting, transporting, and applying. If anything is wrong with the processing, the boxes will not seal properly, the packaging line must be stopped, and the problem identified and fixed.

Re-activation or heat sealing of pre-applied adhesives is known and practiced in the art. Heat sealed closures and seams are commonly used in the manufacture of bags, whereby adhesive is coated on the inside of the bag seam and subsequently sandwiched under intense heat and pressure using heated platens or bars. This direct application of heat and pressure renders the adhesive molten, after which a bond is formed. This application benefits from the ability to apply steady direct pressure to ensure intimate contact and sufficient wetting of the adhesive layer to the substrate. This process cannot be used for applications where high pressure for closing is not available, such as in case and carton packaging processes. While focused hot air has been used in the reactivation of pre-applied adhesives used in case and carton sealing operations, this method requires extremely large amounts of energy and can result in undesired heating of the substrate or package, its contents, and the surrounding area and equipment. Moreover, line speed is slow.

While ultrasonic welding has been used in the art to join one substrate to another, this technology is effective only when the two substrates are made of the same material. This technique is not effective in joining substrates made of different materials.

A need exists in the art for a packaging system that can advantageously be used for case and carton sealing whereby the case or carton to be filled is provided to the packager with adhesive already applied to the case or carton and later, during packaging, re-activated in order to close or seal the case or carton. The current invention addresses this need.

### SUMMARY OF THE INVENTION

The invention provides a means and an adhesive composition that may be preapplied to a substrate and, when ready to use, reactivated upon exposure to ultrasonic waves. The reactivatable adhesives of the invention may advantageously be used in case and carton sealing applications.

One aspect of the invention is directed to a reactivatable adhesive composition that is reactivatable upon exposure to ultrasonic energy of from about 15 kilohertz to about 60 kilohertz, more preferably from about 20 kHz to about 40 kHz. The reactivatable adhesive comprising at least one energy absorbing ingredient, in particular, a polymer sensitive to ultrasonic compression.

Another aspect of the invention is directed to a substrate comprising a reactivatable adhesive that has been applied to at least a portion of a first substrate and allowed to solidify. Upon subsequent exposure to ultrasonic wave energy, the adhesive melts to the extent that it is capable of bonding the first substrate to a second substrate.

Yet another aspect of the invention is directed to a process for bonding at least a first substrate to at least a second substrate, wherein at least a portion of at least one of said substrates has applied thereon a reactivatable adhesive capable of reactivating upon exposure to ultrasonic waves. The method comprises contacting the surface of the substrate having said reactivatable adhesive applied thereto with ultrasonic energy for a time sufficient to melt the adhesive, bringing one of said substrates in contact with the melted adhesive on the other substrate, and allowing the adhesive to solidify thereby bonding the first substrate to the second substrate.

An alternative embodiment is directed to a process for bonding at least a first substrate to at least a second substrate, wherein at least a portion of at least one of said substrates has applied thereon a reactivatable adhesive capable of reactivating upon exposure to ultrasonic waves. The method comprises bringing one of said substrates in contact with the adhesive preapplied the other substrate, contacting the surface of the first and/or second substrate, said reactivatable adhesive located there between, with ultrasonic energy for a time sufficient to melt the adhesive, and thereafter allowing the adhesive to solidify thereby bonding the first substrate to the second substrate.

In the practice of the invention, the reactivatable adhesive containing an energy absorbing ingredient is reactivated using an ultrasonic energy source. Sources of ultrasonic energy include ultrasonic horns such as rectangular horns and rotary horns of cylindrical shape.

Still another aspect of the invention is directed to articles of manufacture comprising a reactivatable adhesive capable of being reactivated upon exposure to ultrasonic energy. Articles encompassed by the invention include, but are not limited to, containers such as cases, cartons, boxes, trays, tubes and bags, and nonwoven absorbent articles such as diapers, more particularly substrates use in the manufacture thereof.

Another aspect of the invention is directed to a method of closing a container having applied on at least one surface substrate thereof the reactivatable adhesive capable of being reactivated upon exposure to ultrasonic energy. The method comprises exposing the surface of the substrate having said reactivatable adhesive applied thereto with ultrasonic energy for a time sufficient to reactivatable the adhesive, bringing a second surface substrate in contact with the reactivated adhesive on the first surface substrate and, optionally, applying pressure to effect said closing. In the practice of the invention, ultrasonic energy is typically applied for periods of less that about 10 seconds. Pressure is typically applied for periods of less than about 30 seconds.

An alternative embodiment is directed a method comprising bringing one of said substrates in contact with the adhesive preapplied the other substrate, contacting the surface of the first and/or second substrate, said reactivatable adhesive located there between, with ultrasonic energy for a time sufficient to melt the adhesive, and thereafter allowing the adhesive to solidify thereby bonding the first substrate to the second substrate.

### DETAILED DESCRIPTION OF THE INVENTION

Consumer product manufacturers often procure raw materials from a number of suppliers. The finished products often require sealing of the packaging materials or laminating several raw materials together. The sealing and laminating work is not desirable for the consumer product manufactures (e.g., food, drug, diaper) since it involves the handling of adhesives at possibly elevated temperature. Safety and contamination are some of their concerns. Therefore, it is desirable to supply to these manufacturers raw materials with a pre-applied layer of adhesive.

While a number of prior art reactivation processes exist such as thermal radiation (ultraviolet, infrared, visible light), and pressure, certain limitations in terms of efficiency, safety, cosmetic efficiency and ease of usage exists with these reactivation methods.

The current invention provides a safe and convenient means to reactivate the adhesive layer and achieve fast and satisfactory bonding of various substrates. The adhesives are first melted at elevated temperature and then coated on the substrates. These pre-applied substrates are stored at room temperature where the adhesives are inactive. At a desired time, e.g., the finish line at the manufacturer's site, these substrates are subjected to ultrasonic compression. The adhesives are subsequently melted/reactivated and good bonding/sealing is achieved. In addition, the reactivation of the adhesives is highly localized and does not affect other areas of the product.

Conventional ultrasonic welding typically involves the welding of same or similar substrates. Dissimilar substrates usually result in poor bonding because one of the substrates will preferentially melt and flow. Use of an ultrasonically responsible adhesive layer overcomes this deficiency and enables welding of dissimilar substrates.

It has now been discovered that the characteristics of an adhesive can be tailored so as to optimize the materials re-activation and subsequent bond formation using ultrasonic energy. The current invention provides a composition and means by which an applied adhesive can be melted or heated in a more efficient manner and enable the bonding of one substrate to another.

Reactivation, as this term is used herein, refers to an adhesive that resides on at least a portion of at least one substrate to be bonded. That is, the adhesive has been applied to a substrate in the molten state and allowed to cool, i.e., solidify, thereon. The application of the adhesive onto a substrate for later activation or “reactivation” is referred to herein, and in the art as a “pre-applied” adhesive. The adhesive present on the substrate may be reactivated anytime after initial application to the substrate for bonding to a second substrate.

The reactivation efficiency of an adhesive refers to the ability of the adhesive to reactive, e.g., become molten in a short period of time. Reactivation efficiency will depend on the compression pressure, the power and frequency of the ultrasound, the geometry and contact area of the ultrasonic horn and the exposure time.

The adhesive present on the substrate is thereafter reactivated or heated to a molten state, brought in contact with a second substrate and allowed to cool or solidify, thereby bonding the two substrate together. Alternative, the adhesive present on the substrate may be brought in contact with a second substrate, reactivated and allowed to cool or solidify, thereby bonding the two substrates together.

Bonding refers to the attaching, joining, adhering, connecting, or the like, of two elements (e.g., substrates). Two elements are considered bonded together when they are bonded not directly together, but at least partially indirectly to one another, e.g., as when each element is at least partially directly bonded to an adhesive layer located between the two elements. The adhesive layer may be continuous or discontinuous.

The improved re-activation and performance is achieved by incorporating into an adhesive an energy-absorbing ingredient. Energy absorbing ingredients are substances sensitive of ultrasonic energy. Examples include thermoplastics, thermosets, low Tg polymers, composites and blends thereof.

The type of adhesive that can be reactivated in accordance with the invention and the method of applying the adhesive to the substrate is not particularly limiting or critical to the practice of the invention, as long as the adhesive is reactivatable upon exposure to ultrasonic energy. Reactivatable adhesives encompassed by the invention include but are not limited to hot melt adhesives, waterborne adhesives, solvent borne adhesives, moisture curable adhesives, ultraviolet curable adhesives, blocked urethane systems, epoxy adhesives, acrylics and silicones. Thermoplastic and hot melt adhesives are particularly useful when formulated for pre-application and subsequent later reactivation and are particularly useful for case and carton sealing. It will be appreciated that a thermoplastic adhesive present on a substrate may be applied to a substrate in the form of a waterborne emulsion or solution.

Packages or containers are used interchangeably herein and include cartons, cases, trays, bags, boxes and the like. I.e., anything used to package a consumer goods such as food and beverages, pharmaceuticals, cosmetics, breakfast cereals, beverage containers (e.g., beer bottles and the like), bakery items, dry foods (e.g., dog food), produce, household products, paper products, soaps and detergents, candy, wet food, frozen food, diapers and the like, and hard goods such as but not limited to tools, fasteners, automotive parts, and light bulbs. While the term case is generally used in the art to refer to outer shipping containers typically made of corrugated paperboard and the term carton is generally used in the art to refer to a container typically manufactured from solid fiber (e.g., a cereal box), the invention will hereinafter refer generally to the manufacture of a “carton.” It is to be understood however that the invention is not to be so limited.

Any conventional polymers suitable for use in formulating adhesives, as are well known to those skilled in the art, may be used in the practice of the invention. Typically, adhesive formulations to which the additive of the invention may be added comprise a wax or diluent, a thermoplastic polymer and a tackifier. In all cases, the adhesive may be formulated with tackifying resins, plasticizers, waxes and/or other conventional additives such as antioxidants and stabilizers in varying amounts as are known to those skilled in the art and as required for particular formulations.

Suitable energy-absorbing additives, e.g., polymers, for use in reactivatable adhesives of the invention may be identified by blending desired additives using methods conventional and well know in the art, coating the adhesive onto a suitable substrate, applying ultrasonic energy and testing for reactivation efficiency and bonding performance. Reactivation efficiency is the ability the adhesive to become molten in a short period of time. Suitable polymer are those that reactivate quickly and exhibit acceptable bond strength.

Any base polymer suitable for use in formulating adhesives, as are well known to those skilled in the art, may be used in the practice of the invention. Such polymers include amorphous polyolefins, ethylene-containing polymers and rubbery block copolymers, as well as blends thereof. Adhesive compositions based on ethylene/vinyl acetate copolymers, isotactic or atactic polypropylene, styrene-butadiene, styrene-isoprene, or styrene-ethylene-butylene A-B-A or A-B-A-B block copolymers or mixtures thereof may be used. In addition to the base polymer, the adhesive compositions of the invention may also contain tackifiers, oils and/or waxes as well as conventional additives including stabilizers, anti-oxidants, pigments and the like.

Useful polymers include block or multi-block copolymers having the general configuration: A-B-A or A-B-A-B-A-B- wherein the polymer blocks A are non-elastomeric polymer blocks which, as homopolymers have glass transition temperatures above 20° C., while the elastomeric polymer blocks B are butadiene or isoprene or butadiene isoprene.

The non-elastomeric blocks may comprise homopolymers or copolymers of vinyl monomers such as vinyl arenes, vinyl pyridines, vinyl halides and vinyl carboxylates, as well as acrylic monomers such as acrylonitrile, methacrylonitrile, esters of acrylic acids, etc. Monovinyl aromatic hydrocarbons include particularly those of the benzene series such as styrene, vinyl toluene, vinyl xylene, ethyl vinyl benzene as well as dicyclic monovinyl compounds such as vinyl naphthalene and the like. Other non-elastomeric polymer blocks may be derived from alpha olefins, alkylene oxides, acetals, urethanes, etc.

The elastomeric block component of the copolymer may be isoprene or butadiene which may or may not be hydrogenated. Further, they may be linear or branched. Typical branched structures contain an elastomeric portion with at least three branches which can radiate out from a central hub or can be otherwise coupled together.

Hydrogenation may be either partial or substantially complete. Selected conditions may be employed for example to hydrogenate the elastomeric block while not so modifying the non-elastomeric blocks. Other conditions may be chosen to hydrogenate substantially uniformly along the polymer chain, both the elastomeric and non-elastomeric blocks thereof being hydrogenated to practically the same extent, which may be either partial or substantially complete.

Typical of the rubbery block copolymers useful herein are the polystyrene-polybutadiene-polystyrene, polystyrene-polyisoprene-polystyrene and e.g., polystyrene-poly-(ethylenebutylene)-polystyrene and polystyrene-poly-(ethylenepropylene)-polystyrene. These copolymers may be prepared using methods taught, for example, in U.S. Pat. Nos. 3,239,478; 3,427,269; 3,700,633; 3,753,936; and 3,932,327. Alternatively, they may be obtained from Kraton Chemical Co. under the trademarks Kraton 1101, 1102, 1107, 1650, 1652 and 1657; from Enichem under the Europrene Sol-T tradenames; and from Firestone under the tradename Stereon 840A. Adhesives based on rubbery block copolymers are described in U.S. Pat. Nos. 4,526,577, 4,944,993, 5,603,948 and others.

The adhesive of the invention may comprise at least one ethylene copolymer, and may comprise a blend of two or more polymers. The term ethylene copolymer, as used herein, refers to homopolymers, copolymers and terpolymers of ethylene. Examples of ethylene copolymers include copolymers with one or more polar monomers which can copolymerize with ethylene, such as vinyl acetate or other vinyl esters of monocarboxylic acids, or acrylic or methacrylic acid or their esters with methanol, ethanol or other alcohols. Included are ethylene vinyl acetate, ethylene methyl acrylate, ethylene n-butyl acrylate, ethylene acrylic acid, ethylene methacrylate and mixtures and blends thereof. Random and block copolymers, as well as blends thereof may be used in the practice of the invention.

Other adhesive compositions may be prepared according to the invention using, as a base polymer, amorphous polyolefins or blends thereof. Amorphous polyolefins are made by the stereospecific polymerization of polypropylene. Suitable commercial products include Eastman's P 1010. Copolymers of amorphous polypropylene and ethylene, amorphous polypropylene and butene and amorphous polypropylene and hexene are suitable as a base polymer, as are terpolymers of propylene, butene and ethylene. Commercial examples include Rextac 2315 (copolymer of amorphous polypropylene and ethylene) available from Rexene, Rextac 2730 (copolymer of amorphous polypropylene and butene) also available from Rexene and Vestoplast 750 and 708 (terpolymers of amorphous propylene, butene and ethylene) available from Huls.

Blends of any of the above base materials, such as blends of ethylene n-butyl acrylate and ethylene vinyl acetate and ethylene vinyl acetate and atactic polypropylene may also be used to prepare adhesive compositions reactivatable by ultrasonic energy. In all cases, the adhesives may be formulated with tackifying resins, plasticizers, waxes and/or other conventional additives in varying amounts as are known to those skilled in the art and as required for particular formulation.

Tackifying resins useful in the adhesive compositions of this invention include hydrocarbon resins, synthetic polyterpenes, rosin esters, natural terpenes, and the like. More particularly, and depending upon the particular base polymer, the useful tackifying resins may include any compatible resins or mixtures thereof such as natural and modified rosins including, for example, as gum rosin, wood rosin, tall oil rosin, distilled rosin, hydrogenated rosin, dimerized rosin, and polymerized rosin; glycerol and pentaerythritol esters of natural and modified rosins, including, for example as the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin; copolymers and terpolymers of natured terpenes, including, for example, styrene/terpene and alpha methyl styrene/terpene; polyterpene resins having a softening point, as determined by ASTM method E28-58T, of from about 80° C. to 150° C.; phenolic modified terpene resins and hydrogenated derivatives thereof including, for example, the resin product resulting from the condensation, in an acidic medium, of a bicyclic terpene and a phenol; aliphatic petroleum hydrocarbon resins having a Ball and Ring softening point of from about 70° C. to 135° C.; aromatic petroleum hydrocarbon resins and the hydrogenated derivatives thereof; and alicyclic petroleum hydrocarbon resins and the hydrogenated derivatives thereof. Mixtures of two or more of the above described tackifying resins may be required for some formulations.

Various plasticizing or extending oils are also present in the composition in amounts of 5% to about 30%, preferably 5 to 25%, by weight in order to provide wetting action and/or viscosity control. Even higher levels may be used in cases where block copolymer containing hydrogenated mid-block are employed as the adhesive base polymer. The above broadly includes not only the usual plasticizing oils but also contemplates the use of olefin oligomers and low molecular weight polymers as well as vegetable and animal oil and their derivatives. The petroleum derived oils which may be employed are relatively high boiling materials containing only a minor proportion of aromatic hydrocarbons (preferably less than 30% and, more particularly, less than 15% by weight of the oil). Alternatively, the oil may be totally non-aromatic. The oligomers may be polypropylenes, polybutenes, hydrogenated polyisoprene, hydrogenated polybutadiene, or the like having average molecular weights between about 350 and about 10,000. Vegetable and animal oils include glyceryl esters of the usual fatty acids and polymerization products thereof.

Various petroleum derived waxes may also be used in amounts less than about 15% by weight of the composition in order to impart fluidity in the molten condition of the adhesive and flexibility to the set adhesive, and to serve as a wetting agent for bonding cellulosic fibers. The term “petroleum derived wax” includes both paraffin and microcrystalline waxes having melting points within the range of 130° F. to 225° F. as well as synthetic waxes such as low molecular weight polyethylene or Fisher-Tropsch waxes.

An antioxidant or stabilizer may also be included in the adhesive compositions described herein in amounts of up to about 3% by weight. Among the applicable antioxidants or stabilizers are high molecular weight hindered phenols and multifunctional phenols such as sulfur and phosphorous-containing phenols. Representative hindered phenols include: 1,3,5-trimethyl 2,4,6-tris (3,5-di-tert-butyl-4-hydroxy-benzyl)benzene; pentaerythritol tetrakis-3(3,5-di-tert-butyl-4-hydroxyphenyl)-propionate; n-octadecyl-3,5-di-tert-butyl-4-hydroxyphenol)-propionate; 4,4′-methylenebis (2,6-tert-butylphenol); 4,4′-thiobis (6-tert-butyl-o-cresol); 2,6-di-tertbutylphenol; 6-(4-hydroxyphenoxy)-2,4-bis(n-octyl-thio)-1,3,5-triazine; di-n-octadecyl 3,5-di-tert-butyl-4-hydroxy-benzyl-phosphonate; 2n-octylthio)-ethyl 3,5-di-tert-butyl-4-hydroxy-benzoate and sorbitol hexa[3-(3,5-ditert-butyl-4-hydroxyphenyl)-propionate].

Other additives conventionally used in formulating adhesive compositions to satisfy different properties and meet specific application requirements also may be added to the adhesive composition of this invention. Such additives include, for example, fillers, pigments, flow modifiers, dyestuffs, which may be incorporated in minor or larger amounts into the adhesive formulation, depending on the purpose.

Preferred formulations for the adhesive layer will comprise styrene-butadiene-styrene copolymers, ethylene vinyl acetate, a wax and a tackifier. Elastomeric adhesives with glass transition temperatures below 20 C, or semicrystalline polymers with a melting temperature of below about 20 C are particularly preferred.

Preferred reactivatable adhesive will reactivate upon exposure to ultrasonic energy having a frequency of from about 15-kilohertz to about 60 kilohertz, more preferably from about 20 kilohertz to about 40 kilohertz. Preferably, the reactivatable adhesives are formulated to reactivate to a temperature of at least about 200° F., more preferably to a temperature of at least about 250° F. upon exposure of less than about 2000 watts/sq inch of ultrasonic energy for a period of less that about 10 seconds, more preferably less than about 5 seconds, even more preferably less than about 3 seconds.

Ultrasonic generators used in the practice of the invention generally and conventionally comprise a transducer, a booster and horn. A booster is typically used to amplify and boost energy. Ultrasonic horns are known in the art and include rectangular horns and rotary horns of cylindrical shape. Preferred geometry for use in the practice of the invention is to press the ultrasound horn onto substrate layers where the adhesive layer is sandwiched in the middle. Alternatively, the substrate may be pressed into the horn. The ultrasonic energy will typically be used at a frequency of from about 15 kilohertz to about 60 kilohertz, more preferably from about 20 kilohertz to about 40 kilohertz.

The adhesive formulations of the invention may be pre-applied in a continuous or discontinuous, e.g., as evenly spaced beads or dots, manner depending on surface area and coating weight desired. Particular patterns may be used to optimize substrate/adhesive contact. Depending on the adhesive, the bead size, thickness, distance apart and pattern will vary.

The adhesive may be pre-applied to the substrate by any method known in the art, and include, without limitation roll coating, painting, dry-brushing, dip coating spraying, slot-coating, swirl spraying, printing (e.g., ink jet printing), flexographic, extrusion, atomized spraying, gravure (pattern wheel transfer), electrostatic, vapor deposition, fiberization and/or screen printing. The method of pre-application to the substrate is not critical to the practice of the invention, but may be selected depending on e.g., end use application, packaging design or like consideration.

The adhesives of the invention find use in packaging, converting, bookbinding, bag ending and in the nonwovens markets. The adhesives find particular use as case, carton, and tray forming, and as sealing adhesives, for example in the packaging of cereals, cracker and beer products. Encompassed by the invention are containers, e.g., cartons, cases, boxes, bags, trays and the like, wherein the adhesive is applied by the manufacturer thereof prior to shipment to the packager. Following packaging, the container is sealed by reactivating the preapplied adhesive using ultrasonic energy.

Substrate to be bonded include a cellulosic substrates, a thermoplastic substrates, a metallic substrates, and combinations thereof. The substrates to be bonded include virgin and recycled Kraft, high and low density Kraft, chipboard, wood and various types of treated and coated Kraft and chipboard. Composite materials are also used for packaging applications such as for the packaging of alcoholic beverages. These composite materials may include chipboard laminated to an aluminum foil which is further laminated to film materials such as polyethylene, Mylar, polypropylene, polyvinylidene chloride, ethylene vinyl acetate and various other types of films. Additionally, these film materials also may be bonded directly to chipboard or Kraft. The aforementioned substrates by no means represent an exhaustive list, as a tremendous variety of substrates, especially composite materials, find utility in the packaging industry.

The invention is further illustrated by the following non-limiting examples.

### EXAMPLES

In the examples that follow, adhesive in a bead shape form and a coat weight of 1.5 g/m was cast onto paperboard substrates 2 inches long, 1 inch wide and 2 mm thick and cooled down to room temperature. After 24 hours, a second substrate was placed upon the adhesive bead present on the paperboard substrate. Second substrates tested were paperboard and plastic. The substrate layers with the reactivatable adhesive layer sandwiched in the middle thereof was pressed into an ultrasonic horn with booster and ultrasonic energy 20 kHz was applied for 5 seconds. 24 hours following ultrasonic bonding the substrates were pulled apart and resulting bond force, adhesive bead flatness and the percent fiber tear recorded.

### Example 1

An ethylene vinyl acetate (EVA) based adhesive available from National Starch and Chemical Company (Product 34-2125) and used in case and carton sealing applications was used to precoat adhesive onto a substrate. This adhesive contains about 30 wt % of a wax; about 35 wt % of a tackifier; about 35 wt % of EVA polymer; and about 1 wt % of an antioxidant.

Good bond strength, almost total bead flatness and 100 fiber tear is observed with both the paperboard and the plastic substrates.

### Example 2

A styrene-butadiene rubber (SBR) based adhesive available from National Starch and Chemical Company (Product 34-5610) and used for nonwoven applications was used to precoat adhesive onto a substrate. This adhesive contains about 55 wt % tackifier; about 25 wt % SBR polymer; about 20 wt % diluent oil; and about 1 wt % antioxidant. Good bond strength, almost total bead flatness and 100 fiber tear is observed with both the paperboard and the plastic substrates.

### Example 3

An ethylene vinyl acetate based adhesive available from National Starch and Chemical Company (Product No. 40-1103) was used to precoat a substrate. This adhesive contains about 88 wt % EVA base resin, 8 wt % plasticizer, 0.2 wt % surfactant and water. Good bond strength, almost total bead flatness and 100 fiber tear is observed with both the paperboard and the plastic substrates.

Good bond strength, almost total bead flatness and 100 fiber tear is observed with both the paperboard and the plastic substrates. This adhesive is particular good for vinyl laminating.

### Example 4

An adhesive comprising about 42 wt % of a neoprene latex base resin, about 42% of a tackifier, about 10% of a styrene butadiene polymer and water (available from National Starch and Chemical Company, Product No. 40-801 A) was used to precoat a substrate.

Good bond strength, almost total bead flatness and 100 fiber tear is observed with both the paperboard and the plastic substrates.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. An adhesive which has been applied to at least a portion of a first substrate and allowed to solidify, said adhesive being reactivatable upon exposure to ultrasonic energy whereupon the adhesive is capable of bonding the first substrate to a second substrate.

2. The substrate of claim 1 where the adhesive reactivates upon exposure to ultrasonic energy having a frequency of from about 15 kilohertz to about 60 kilohertz.

3. The substrate of claim 1 wherein the adhesive reactivates to a temperature of at least about 200° F. upon exposure of less than about 2000 watts/sq inch of ultrasonic energy for a period of less that about 10 seconds.

4. The substrate of claim 1 wherein the adhesive was applied to the substrate by roll coating, painting, dry-brushing, dip coating spraying, slot-coating, swirl spraying, ink jet printing, flexographic printing, extrusion, atomized spraying, gravure, electrostatic, vapor deposition, fiberization and/or screen printing.

5. The substrate of claim 1 which is a hot melt adhesive.

6. The substrate of claim 1 which was applied to the substrate as a waterborne adhesive.

7. A method for bonding at least a first substrate to at least a second substrate, wherein at least a portion of at least one of said substrates has applied thereon a reactivatable adhesive capable of reactivating upon exposure to ultrasonic energy, said method comprising contacting the surface of the substrate having said reactivatable adhesive applied thereto with ultrasonic energy for a time sufficient to melt the adhesive, bringing one of said substrates in contact with the melted adhesive on the other substrate, and allowing the adhesive to solidify thereby bonding the first substrate to the second substrate.

8. A method for bonding at least a first substrate to at least a second substrate, wherein at least a portion of at least one of said substrates has applied thereon a reactivatable adhesive capable of reactivating upon exposure to ultrasonic waves, the method comprising bringing one of said substrates in contact with the reactivatable adhesive applied the other substrate, contacting the surface of the first and/or second substrate, said reactivatable adhesive located there between, with ultrasonic energy for a time sufficient to melt the adhesive, and thereafter allowing the adhesive to solidify thereby bonding the first substrate to the second substrate.

9. A method of closing a container having applied on at least one surface substrate thereof a reactivatable adhesive capable of being reactivated upon exposure to ultrasonic energy, the method comprises exposing the surface of the substrate having said reactivatable adhesive applied thereto with ultrasonic energy for a time sufficient to reactivatable the adhesive, bringing a second surface substrate in contact with the reactivated adhesive on the first surface substrate and, optionally, applying pressure to effect said closing.

10. A method of closing a container having applied on at least one surface substrate thereof a reactivatable adhesive capable of being reactivated upon exposure to ultrasonic energy, the method comprising bringing one of said substrates in contact with the adhesive preapplied the other substrate, contacting the surface of the first and/or second substrate, said reactivatable adhesive located there between, with ultrasonic energy for a time sufficient to melt the adhesive, and thereafter allowing the adhesive to solidify thereby bonding the first substrate to the second substrate.

11. An article of manufacture prepared by bonding the substrate of claim 1 to a second substrate.

12. The article of claim 11 wherein said article is a container.

13. The article of claim 12 wherein the container is a case, carton, tray or bag.

14. The article of claim 13 wherein the container is a case.

15. The article of claim 13 wherein the container is a carton.

16. The article of claim 12 wherein the container is a tube.

17. The article of claim 11 wherein said article is nonwoven absorbent article.

18. The article of claim 17 wherein the absorbent article is a diaper.
